(19) United States
(12) Patent Application Publication
(10) Pub. No.: US 2014/0250158 A1
(43) Pub. Date: Sep. 4, 2014

(54) METHOD AND DEVICE FOR OBTAINING FILE

(71) Applicant: TENCENT TECHNOLOGY (SHENZHEN) COMPANY LIMITED, Shenzhen City (CN)

(72) Inventor: KUN TANG, Shenzhen City (CN)

(73) Assignee: TENCENT TECHNOLOGY (SHENZHEN) COMPANY LIMITED, Shenzhen City (CN)

(21) Appl. No.: 14/280,639

(22) Filed: May 18, 2014

Related U.S. Application Data
(63) Continuation of application No. PCT/CN2012/076972, filed on Jul. 9, 2012.

(30) Foreign Application Priority Data
Nov. 18, 2011 (CN) 201110367696.8

(51) Int. Cl. G06F 17/30

(52) U.S. Cl. CPC G06F 17/30194
USPC 707/827

(57) ABSTRACT

A method and a system for obtaining a file are provided by this invention which adapts to computer field. The method includes the following steps: obtaining a file size of a target file; determining whether the file size of the target file is larger than a maximum file size transfer limit; and if yes, obtaining a file segment of the target file each time, until the entire target file being obtained, wherein the file segment is segmented from the target file according to the maximum file size transfer limit.

### CROSS REFERENCE TO RELATED APPLICATIONS

This application is a continuation application of PCT Patent Application No. PCT/CN2012/076972 filed on Jul. 9, 2012, which claims benefit of Chinese Patent Application No. CN201110367696.8, filed on Nov. 18, 2011, which are hereby incorporated herein by reference in its entirety.

### FIELD OF THE INVENTION

The present invention relates to computer field, and more particularly to a method and a device for obtaining a file.

### BACKGROUND OF THE INVENTION

With continuous development of browser (also refers to web browser) technology, users download files through the browser has become an indispensable part of the main feature of the browser.

Conventional, when a browser on a client device downloads a file from a source server, a Socket connection is established between the browser on a client device and a source server. After being connected, the browser on the client device makes a request for obtaining a file to the source server. When the source server accepts the request, the source server will pre-read the file into the cache for transmission to the client device. And then, according to the source server settings, the source server will read the entire file or multiple segments according to a preset size to read until the reading is completed. After each time of reading, the source server transmits the reading contents of to the client device, thus completing a download task.

However, when there is no response in the Socket communications link, the connection would not have been maintained. So when the downloaded file is relatively large, and the server is set up to read the file to the cache for each large segment or read the entire file, the connection between the client device and the source server will be disconnected, because the server takes a long time to read the file, and the two sides have no transmission of data. The disconnection between the client device and the source server causes the file download is unsuccessful, and the user will be affected.

### SUMMARY OF THE INVENTION

The embodiments of the present invention provide a method and a device for obtaining a file, to avoid the problem of unsuccessful file download, due to the server takes a long time to read the large file, and the client device and the server have no transmission of data for a long time. 1

The method is illustrative of the invention and the principles associated with the method are applicable to the device and computer readable medium.

Technical solutions provided by embodiments of the present invention includes:

A method for obtaining a file, the method includes: obtaining a file size of a target file; determining whether the file size of the target file is larger than a maximum file size transfer limit; and if yes, obtaining a file segment of the target file each time, until the entire target file being obtained, wherein the file segment is segmented from the target file according to the maximum file size transfer limit.

Preferably, the step of obtaining a file size of a target file includes sending a request information to a server for obtaining the file size of the target file; and receiving a response information sending back from the server according to the request information, and obtaining the file size of the target file from a message header information of the response information.

Preferably, the step of obtaining a file segment of the target file each time, until the entire target file being obtained includes: requesting for obtaining a file segment; once the file segment being obtained, determining whether a remaining size of the target file is larger than the maximum file size transfer limit, wherein the remaining size is a file size of the target file removing the part has been obtained; if the remaining size is larger than the maximum file size transfer limit, obtaining another file segment; if the remaining size is smaller than or equal to the maximum file size transfer limit, obtaining the target file removing the part has been obtained.

Preferably, the step of obtaining a file size of a target file includes: sending a request information to a server for obtaining a first file segment of the target file, wherein the request information further comprises a request for obtaining the file size of the target file and a size of the first file segment; and obtaining the first file segment and receiving a response information sending back from the server according to the request information, wherein the response information comprises the file size of the target file and the size of the first file segment.

Preferably, the step of obtaining a file segment of the target file each time, until the entire target file being obtained, includes: requesting for an un-obtained file segment; once one un-obtained file segment being obtained, determining whether a remaining size of the target file is larger than the maximum file size transfer limit, wherein the remaining size is a file size of the target file removing the part has been obtained; if the remaining size is larger than the maximum file size transfer limit, obtaining another file segment; if the remaining size is smaller than or equal to the maximum file size transfer limit, obtaining the target file removing the part has been obtained.

Another purpose of the present invention is to provide a device for obtaining a file, the device includes: a first obtaining module, configured to obtain a file size of a target file; a determining module, configured to determine whether the file size of the target file is larger than a maximum file size transfer limit; and a second obtaining module, if the file size of the target file is larger than the maximum file size transfer limit, the second obtaining module configured to obtain a file segment of the target file each time, until the entire target file being obtained, wherein the file segment is segmented from the target file according to the maximum file size transfer limit.

Preferably, the first obtaining module includes: a sending unit, configured to send a request information to a server for obtaining the file size of the target file; and a receiving unit, configured to receive a response information sending back from the server according to the request information, and obtaining the file size of the target file from a message header information of the response information.

Preferably, the sending unit is further configured to send a request information to a server for obtaining a file segment, once the obtaining module obtains one file segment, the determining module is further configured to determine whether a remaining size of the target file is larger than the maximum file size transfer limit, wherein the remaining size is a file size of the target file removing the part has been obtained; if the remaining size is larger than the maximum file size transfer limit, the second obtaining module is further configured to obtain another file segment; if the remaining size is smaller than or equal to the maximum file size transfer limit, the second obtaining module is further configured to obtain the target file removing the part has been obtained.

Preferably, the first obtaining module includes: a sending unit, configured to send a request information to a server for obtaining a first file segment of the target file, wherein the request information further comprises a request for obtaining the file size of the target file and a size of the first file segment; and a receiving unit, configured to obtain the first file segment and receive a response information sending back from the server according to the request information, wherein the response information comprises the file size of the target file and the size of the first file segment.

Preferably, the sending unit is further configured to send a request information to a server for obtaining an un-obtained file segment, once one un-obtained file segment being obtained, the determining module is further configured to determine whether a remaining size of the target file is larger than the maximum file size transfer limit, wherein the remaining size is a file size of the target file removing the part has been obtained; if the remaining size is larger than the maximum file size transfer limit, the second obtaining module is further configured to obtain another file segment; if the remaining size is smaller than or equal to the maximum file size transfer limit, the second obtaining module is further configured to obtain the target file removing the part has been obtained.

Further another purpose of the present invention is to provide computer-readable storage medium storing instructions for obtaining a file, the instructions including: obtaining a file size of a target file; determining whether the file size of the target file is larger than a maximum file size transfer limit; and if yes, obtaining a file segment of the target file each time, until the entire target file being obtained, wherein the file segment is segmented from the target file according to the maximum file size transfer limit.

In the embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

### BRIEF DESCRIPTION OF THE DRAWINGS

FIG. 1 illustrates a client device example;

FIG. 2 illustrates a connection between a client device and a server via a network;

FIG. 3 is a flow chart of a method for obtaining a file provided by a first embodiment of the present invention;

FIG. 4 is a flow chart of a method for obtaining a file provided by a second embodiment of the present invention;

FIG. 5 is a flow chart of a method for obtaining a file provided by a third embodiment of the present invention;

FIG. 6 is a block diagram of a device for obtaining a file provided by a fourth embodiment of the present invention;

FIG. 7 is a block diagram of a device for obtaining a file provided by a fifth embodiment of the present invention.

FIG. 8 is a block diagram of a device for obtaining a file provided by a sixth embodiment of the present invention.

### DETAILED DESCRIPTION OF PREFERRED EMBODIMENTS

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

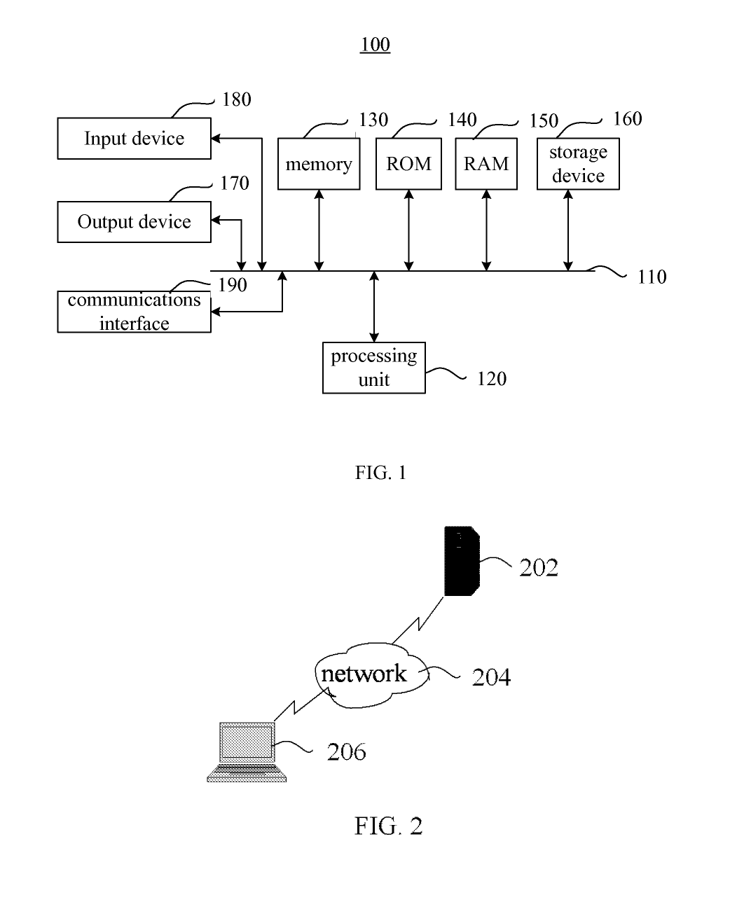

Prior to discussing the details of the method according the invention more fully, the disclosure next presents the basic hardware components associated with the system embodiment of the invention. With reference to FIG. 1, an exemplary system includes a general-purpose client device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a client device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the client device 100, such as during start-up. The client device 100 further includes storage devices such as a hard disk drive 160, a magnetic disk drive, or the like. The storage device 160 is connected to the system bus 110 by a drive interface. The drives and the associated computer readable media provide nonvolatile storage of computer readable instructions, data structures, program modules and other data for the client device 100. The basic components are known to those of skill in the art and appropriate variations are contemplated depending on the type of device, such as whether the device is a small, handheld client device, or a desktop computer.

Although the exemplary environment described herein employs the hard disk, it should be appreciated by those skilled in the art that other types of computer readable media which can store data that are accessible by a computer, such as flash memory cards, random access memories (RAMs), read only memory (ROM), a cable or wireless signal containing a bit stream and the like, may also be used in the exemplary operating environment.

To enable user interaction with the client device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. In some instances, multimodal systems enable a user to provide multiple types of input to communicate with the client device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

FIG. 2 illustrates a connection between a client device (206) and a server (202) via a wireless network (204). While FIG. 2 demonstrates a single client device, many heterogeneous client devices can interface with one or more servers using a variety of wireless networks. For example, different types of smart phones can interface using Wi-Fi, EDGE, 3G, or other wireless protocols with an online storefront operated by a cluster of servers.

The details of the embodiments according the invention will be discussed.

### First Embodiment

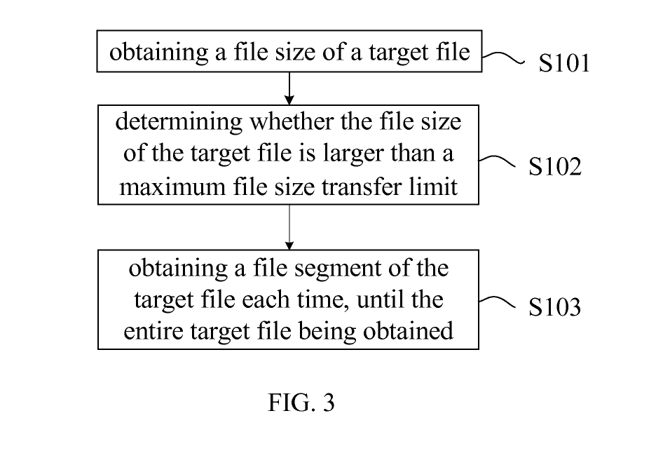

FIG. 3 shows a flow chart of a method for obtaining a file provided by the embodiment of the present invention, specifically exemplified by follows:

In Step 101, a client device obtains a file size of a target file from a server.

In Step 102, the client device determines whether the file size of the target file is larger than a maximum file size transfer limit.

In Step 103, if the file size of the target file is larger than a maximum file size transfer limit, the client device obtains a file segment of the target file from the server each time, until the entire target file being obtained by the client device. The file segment is segmented from the target file according to the maximum file size transfer limit.

In the exemplary embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

### Second Embodiment

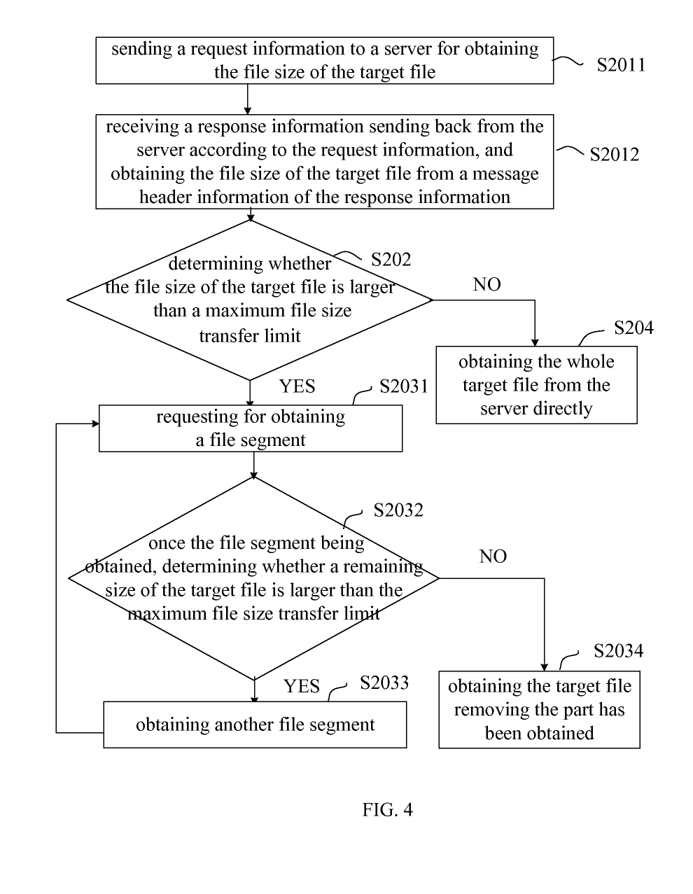

FIG. 4 shows a flow chart of a method for obtaining a file provided by the embodiment of the present invention, specifically exemplified by follows:

In Step 201, a client device obtains a file size of a target file.

When a downloading request of a target file is triggered by a user of a client device, the client device sends a request information to a server for obtaining the file size of the target file. For example, the client device can send a HEAD request to the server according to HTTP protocol. The Socket sends a response information back to the client device as a respond to the HEAD request. The response information includes message header information. The client device obtains the file size of the target file from the message header information.

In the exemplary embodiment, Step 201 can further includes following steps:

In Step 2011, the client device sends a request information to the server for obtaining the file size of the target file.

In Step 2012, the terminal receives a response information sending back from the server according the request information, and obtains the file size of the target file from a message header information of the response information.

In Step 202, the client device determines whether the file size of the target file is larger than a maximum file size transfer limit.

Specific, the maximum file size transfer limit is a segmentation parameter set by the client device to let the server know how big the segment to download each time should be. If the file size of the target file is larger than the maximum file size transfer limit, the target file is segmented into a plurality of file segments according to the maximum file size transfer limit by the server. If the file size of the target file is smaller than or equals to the preset threshold, the target file doesn't need to be segmented.

For example, if the maximum file size transfer limit is set to 100 Kb and the file size of the target file is 450 Kb, the target file will be segmented into four file segments each having 100 Kb size, and one file segment having 50 Kb size as the last file segment. That means, a size of each file segment of the target file to be obtained by the client device each time is 100 Kb except the last time.

If the file size of the target file is larger than the maximum file size transfer limit, the Step 203 will be performed. If the file size of the target file is not larger than the maximum file size transfer limit, the client device sends a request information to the server for obtaining the entire target file directly, a normal file download will be performed until the entire target file is obtained by the client device.

In Step 203, a file segment of the target file each time, until the entire target file being obtained.

In Step 203, the file segments of the target file are obtained by the client device in at least two times. The number of the file segments or how many times the obtaining file segment step will be performed, depends on the file size of the target file and the maximum file size transfer limit. Each time, the client device sends a request for obtaining a file segment to the server firstly, and then, the server reads and stores one file segment of the target file to the server's cache according to the request. Regardless of the file stored in the server's cache is the entire target file, or the file segments, after reading, contents of data link is sent to the client device.

In the exemplary embodiment, Step 203 can further includes following steps:

In Step 2031, the client device requests for obtaining one file segment having a fire size equals to the maximum file size transfer limit.

Once one file segment is obtained, Step 2032 will be performed. In Step 2032, the client device determines whether a remaining size of the target file is larger than the maximum file size transfer limit. The remaining size is a file size of the target file removing the part has been obtained.

If the remaining size of the target file is larger than the maximum file size transfer limit, Step 2033 will be performed. In Step 2033, the client device obtains another file segment.

If the remaining size of the target file is not larger than the maximum file size transfer limit, in other words, if the remaining size is smaller or equal to the maximum file size transfer limit, Step 2034 will be performed. In Step 2034, the client device obtains the target file removing the part has been obtained.

Repeat Steps 2031 to 2033, till the download of the target file is complete.

If the result of the Step 202 is no, that is, if the file size of the target file is smaller or equals to the preset threshold, Step 204 is performed. In Step 204, the client device obtains the whole target file from the server directly.

In the exemplary embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

### Third Embodiment

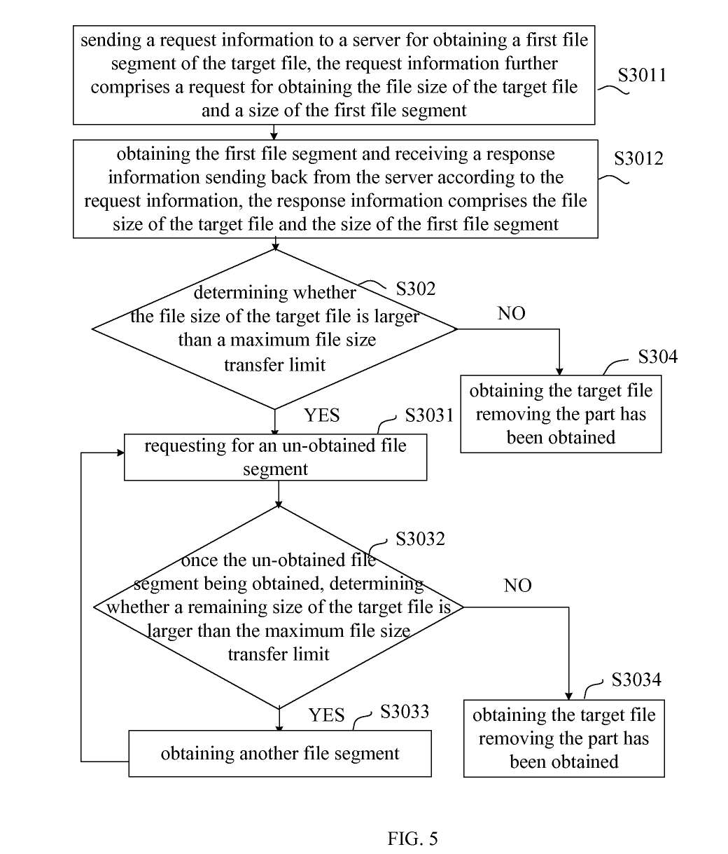

FIG. 5 shows a flow chart of a method for obtaining a file provided by the embodiment of the present invention, specifically exemplified by follows:

In this embodiment, the file size of the target file is obtained when a first segment is obtained.

In Step 301, a file size of the target file is obtained.

Step 301 can further includes:

In Step 3011, a client device sends request information to a server for obtaining a first segment of the target file according to a maximum file size transfer limit. The request information includes a request to obtain a file size of the target file.

When the client device sends the request information, the client device doesn't know the file size of the target file, assuming the file size of the target file is larger than the maximum file size transfer limit, a file size of the first segment is equals to the maximum file size transfer limit. At the same time, the server receives a request for obtaining the file size of the target file.

In Step 3012, the client device receives the first segment of the target file, and a response information sending back from the server.

In Step 302, the client device determines whether the file size of the target file is larger than the maximum file size transfer limit.

The client device knows the file size of the target file and the file size of the first segment. If the file size of the target file is larger than the maximum file size transfer limit, that means the file size of the first segment equals to the maximum file size transfer limit and the download of the target file is not complete. In this case, Step 303 will be performed.

If the file size of the target file is smaller than or equals to the maximum file size transfer limit, that means the file size of the first segment is smaller than the maximum file size transfer limit and the download of the target file is complete. In this case, the first segment is the target file.

In Step 303, if the file size of the target file is larger than the maximum file size transfer limit, the client device obtains each file segment of the target file according to the maximum file size transfer limit, till a last file segment being downloaded.

Step 303 can further includes:

In Step 3031, the client device requests for obtaining a file segment of the target file.

In Step 3032, once the client device obtains one file segment, determines whether a remaining size of the target file is larger than the maximum file size transfer limit. The remaining size is a file size of the target file removing the part has been obtained.

If the remaining size is larger than the maximum file size transfer limit, Step 3033 will be performed.

In Step 3033, the client devices obtains next one file segment.

If the remaining size is smaller than or equal to the maximum file size transfer limit, Step 3034 will be performed.

In Step 3034, the client device obtains the target file removing the part has been obtained.

Once the client device obtains one segment, Step 3031 to 3033 will be repeated.

In the exemplary embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

### Fourth Embodiment

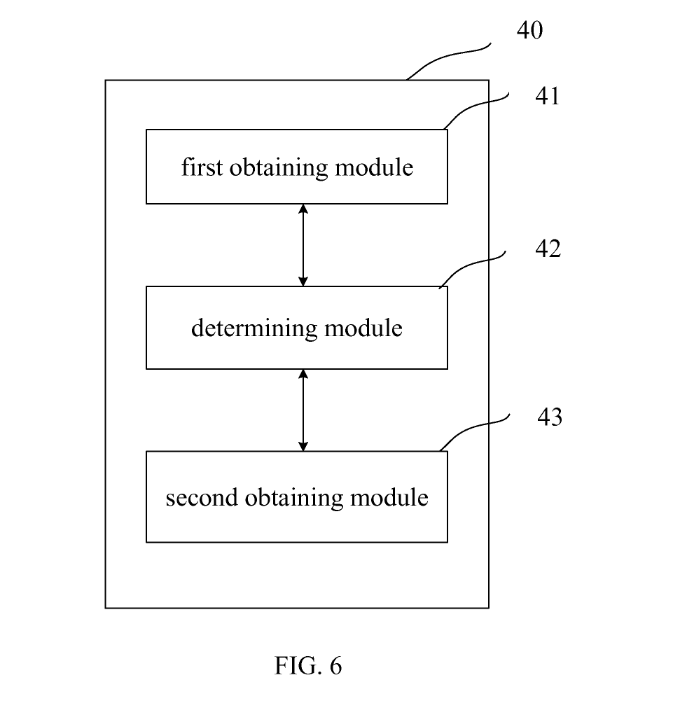

FIG. 6 shows the structure of a device for obtaining a file of the present invention, and in order to facilitate the description, only shows the relevant part of the embodiment of the present invention.

The device can be adapted in client devices, can be implemented in software unit, hardware unit, or soft-hardware compact unit, also can be integrated into the client devices as an independent pendant and implemented in the browser.

In the exemplary embodiment, the device 40 includes a first obtaining module 41, a determining module 42, and a second obtaining module 43.

The first obtaining module 41 is configured to obtain a file size of a target file.

The determining module 42 is configured to determine whether the file size of the target file is larger than a maximum file size transfer limit.

If the file size of the target file is larger than the maximum file size transfer limit, the second obtaining module 43 configured to obtain a file segment of the target file each time, until the entire target file being obtained, wherein the file segment is segmented from the target file according to the maximum file size transfer limit.

In the exemplary embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

### Fifth Embodiment

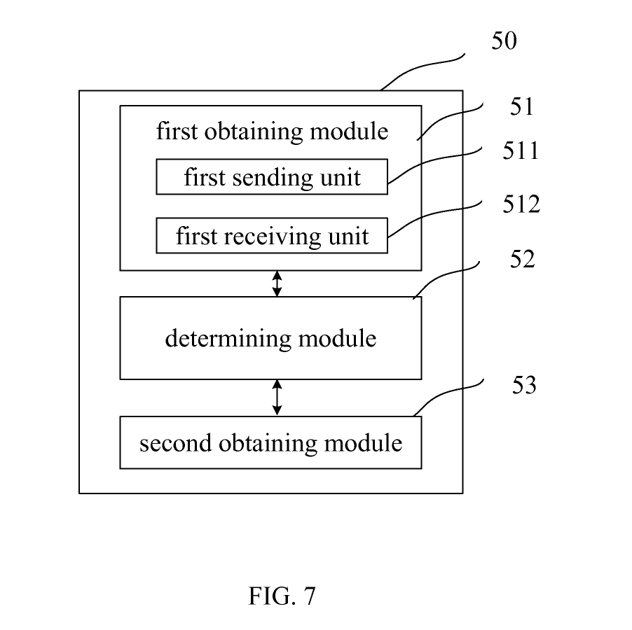

FIG. 7 shows the structure of a device for obtaining a file of the present invention, and in order to facilitate the description, only shows the relevant part of the embodiment of the present invention.

The device can be adapted in client devices, can be implemented in software unit, hardware unit, or soft-hardware compact unit, also can be integrated into the client devices as an independent pendant and implemented in the browser.

In the exemplary embodiment, the device 50 includes a first obtaining module 51, a determining module 52, and a second obtaining module 53.

The first obtaining module 51 is configured to obtain a file size of a target file.

Preferable, in this embodiment, the first obtaining module 51 includes:
a sending unit 511, configured to send a request information to a server for obtaining the file size of the target file; and
a receiving unit 512, configured to receive a response information sending back from the server according to the request information, and obtaining the file size of the target file from a message header information of the response information.

The determining module 52 is configured to determine whether the file size of the target file is larger than a maximum file size transfer limit.

If the file size of the target file is larger than the maximum file size transfer limit, the second obtaining module 53 configured to obtain a file segment of the target file each time, until the entire target file being obtained, wherein the file segment is segmented from the target file according to the maximum file size transfer limit.

Preferable, in this embodiment, the sending unit 511 is further configured to send a request information to a server for obtaining a file segment, once the second obtaining module 53 obtains one file segment, the determining module 52 is further configured to determine whether a remaining size of the target file is larger than the maximum file size transfer limit, wherein the remaining size is a file size of the target file removing the part has been obtained. If the remaining size is larger than the maximum file size transfer limit, the second obtaining module 53 is further configured to obtain another file segment. If the remaining size is smaller than or equal to the maximum file size transfer limit, the second obtaining module 53 is further configured to obtain the target file removing the part has been obtained.

In the exemplary embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

### Sixth Embodiment

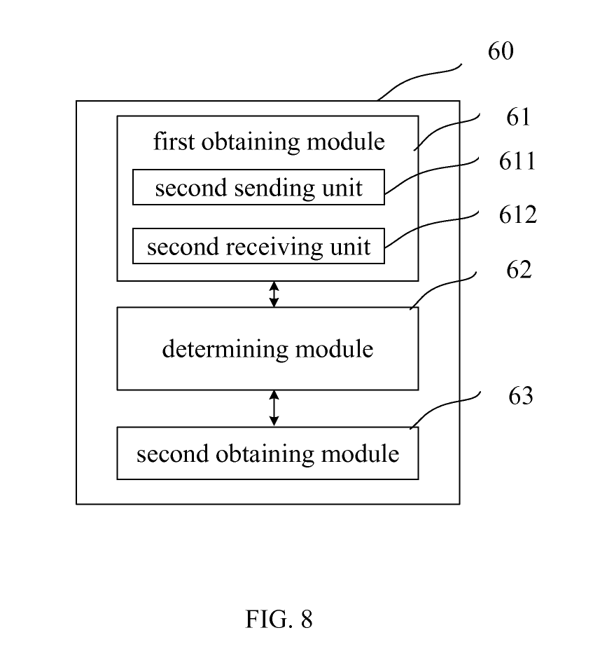

FIG. 8 shows the structure of a device for obtaining a file of the present invention, and in order to facilitate the description, only shows the relevant part of the embodiment of the present invention.

The device can be adapted in client devices, can be implemented in software unit, hardware unit, or soft-hardware compact unit, also can be integrated into the client devices as an independent pendant and implemented in the browser.

In the exemplary embodiment, the device 60 includes a first obtaining module 61, a determining module 62, and a second obtaining module 63.

The first obtaining module 61 is configured to obtain a file size of a target file.

Preferable, in this embodiment, the first obtaining module 61 includes:
a sending unit 611, configured to send a request information to a server for obtaining a first file segment of the target file, wherein the request information further comprises a request for obtaining the file size of the target file and a size of the first file segment; and
a receiving unit 612, configured to obtain the first file segment and receive a response information sending back from the server according to the request information, wherein the response information comprises the file size of the target file and the size of the first file segment.

The determining module 62 is configured to determine whether the file size of the target file is larger than a maximum file size transfer limit.

If the file size of the target file is larger than the maximum file size transfer limit, the second obtaining module 63 configured to obtain a file segment of the target file each time, until the entire target file being obtained, wherein the file segment is segmented from the target file according to the maximum file size transfer limit.

Preferable, in this embodiment, the sending unit 611 is further configured to send a request information to a server for obtaining an un-obtained file segment, once one un-obtained file segment being obtained, the determining module 62 is further configured to determine whether a remaining size of the target file is larger than the maximum file size transfer limit, wherein the remaining size is a file size of the target file removing the part has been obtained. If the remaining size is larger than the maximum file size transfer limit, the second obtaining module 63 is further configured to obtain another file segment. If the remaining size is smaller than or equal to the maximum file size transfer limit, the second obtaining module 63 is further configured to obtain the target file removing the part has been obtained.

In the exemplary embodiments of the present invention, the target file is obtained by a client device in several times, each time the client device only obtain one file segment from the server, thereby forming repeated request and response loop between the client device and the server. The repeated request and response loop between the client device and server maintains the Socket connection therebetween in the file download process. Therefore, the present invention can improve the success rate of file download and improve the user experience.

It can be understood that all or part of the technique solutions provided by the above embodiments can be achieved by programming, and the program can be stored in a computer-readable media. The program is applied to perform the following steps:
obtaining a file size of a target file;
determining whether the file size of the target file is larger than a maximum file size transfer limit; and
if yes, obtaining a file segment of the target file each time, until the entire target file being obtained, wherein the file segment is segmented from the target file according to the maximum file size transfer limit.

Preferably, the step of obtaining a file size of a target file includes sending a request information to a server for obtaining the file size of the target file; and receiving a response information sending back from the server according to the request information, and obtaining the file size of the target file from a message header information of the response information.

Preferably, the step of obtaining a file segment of the target file each time, until the entire target file being obtained includes: request for obtaining a file segment, once the file segment being obtained, determining whether a remaining size of the target file is larger than the maximum file size transfer limit, wherein the remaining size is a file size of the target file removing the part has been obtained; if the remaining size is larger than the maximum file size transfer limit, obtaining another file segment; if the remaining size is smaller than or equal to the maximum file size transfer limit, obtaining the target file removing the part has been obtained.

Preferably, the step of obtaining a file size of a target file includes: sending a request information to a server for obtaining a first file segment of the target file, wherein the request information further comprises a request for obtaining the file size of the target file and a size of the first file segment; and obtaining the first file segment and receiving a response information sending back from the server according to the request information, wherein the response information comprises the file size of the target file and the size of the first file segment.

Preferably, the step of obtaining a file segment of the target file each time, until the entire target file being obtained, includes: requesting for obtaining an un-obtained file segment, once the un-obtained file segment is obtained, determining whether a remaining size of the target file is larger than the maximum file size transfer limit, wherein the remaining size is a file size of the target file removing the part has been obtained; if the remaining size is larger than the maximum file size transfer limit, obtaining another file segment; if the remaining size is smaller than or equal to the maximum file size transfer limit, obtaining the target file removing the part has been obtained.

Preferably, the step of obtaining a file segment of the target file each time, includes: sending a request to a server for obtaining a file segment of the target file; and receiving the file segment sending back from the server.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

The above descriptions are only preferred embodiments of the present invention, and are not intended to limit the present invention. Any amendments, replacement and modification made to the above embodiments under the spirit and principle of the present invention should be included in the scope of the present invention.

What is claimed is:

1. A method for obtaining a file, comprising:
obtaining a file size of a target file;
determining whether the file size of the target file is larger than a maximum file size transfer limit; and
if yes, obtaining a file segment of the target file each time, until the entire target file being obtained, wherein the file segment is segmented from the target file according to the maximum file size transfer limit.

2. The method as claimed in claim 1, wherein the step of obtaining a file size of a target file comprises:
sending a request information to a server for obtaining the file size of the target file; and
receiving a response information sending back from the server according to the request information, and obtaining the file size of the target file from a message header information of the response information.

3. The method as claimed in claim 2, wherein the step of obtaining a file segment of the target file each time, until the entire target file being obtained comprises:
requesting for obtaining a file segment;
once the file segment being obtained, determining whether a remaining size of the target file is larger than the maximum file size transfer limit, wherein the remaining size is a file size of the target file removing the part has been obtained;
if the remaining size is larger than the maximum file size transfer limit, obtaining another file segment; and
if the remaining size is smaller than or equal to the maximum file size transfer limit, obtaining the target file removing the part has been obtained.

4. The method as claimed in claim 1, wherein the step of obtaining a file size of a target file comprises:
sending a request information to a server for obtaining a first file segment of the target file, wherein the request information further comprises a request for obtaining the file size of the target file and a size of the first file segment; and
obtaining the first file segment and receiving a response information sending back from the server according to the request information, wherein the response information comprises the file size of the target file and the size of the first file segment.

5. The method as claimed in claim 4, wherein the step of obtaining a file segment of the target file each time, until the entire target file being obtained, comprises:
requesting for an un-obtained file segment;
once the un-obtained file segment being obtained, determining whether a remaining size of the target file is larger than the maximum file size transfer limit, wherein the remaining size is a file size of the target file removing the part has been obtained;
if the remaining size is larger than the maximum file size transfer limit, obtaining another file segment; and
if the remaining size is smaller than or equal to the maximum file size transfer limit, obtaining the target file removing the part has been obtained.

6. A device for obtaining a file, comprising:
a first obtaining module, configured to obtain a file size of a target file;
a determining module, configured to determine whether the file size of the target file is larger than a maximum file size transfer limit; and
a second obtaining module, if the file size of the target file is larger than the maximum file size transfer limit, the second obtaining module configured to obtain a file segment of the target file each time, until the entire target file being obtained, wherein the file segment is segmented from the target file according to the maximum file size transfer limit.

7. The device as claimed in claim 6, wherein the first obtaining module comprises:
a sending unit, configured to send a request information to a server for obtaining the file size of the target file; and
a receiving unit, configured to receive a response information sending back from the server according to the request information, and obtaining the file size of the target file from a message header information of the response information.

8. The device as claimed in claim 7, wherein the sending unit is further configured to send a request information to a server for obtaining a file segment, once the second obtaining module obtains one file segment, the determining module is further configured to determine whether a remaining size of the target file is larger than the maximum file size transfer limit, wherein the remaining size is a file size of the target file removing the part has been obtained;
if the remaining size is larger than the maximum file size transfer limit, the second obtaining module is further configured to obtain another file segment; and
if the remaining size is smaller than or equal to the maximum file size transfer limit, the second obtaining module is further configured to obtain the target file removing the part has been obtained.

9. The device as claimed in claim 6, wherein the first obtaining module comprises:
a sending unit, configured to send a request information to a server for obtaining a first file segment of the target file, wherein the request information further comprises a request for obtaining the file size of the target file and a size of the first file segment; and
a receiving unit, configured to obtain the first file segment and receive a response information sending back from the server according to the request information, wherein the response information comprises the file size of the target file and the size of the first file segment.

10. The device as claimed in claim 9, wherein the sending unit is further configured to send a request information to a server for obtaining an un-obtained file segment, once one un-obtained file segment being obtained, the determining module is further configured to determine whether a remaining size of the target file is larger than the maximum file size transfer limit, wherein the remaining size is a file size of the target file removing the part has been obtained;
if the remaining size is larger than the maximum file size transfer limit, the second obtaining module is further configured to obtain another file segment; and
if the remaining size is smaller than or equal to the maximum file size transfer limit, the second obtaining module is further configured to obtain the target file removing the part has been obtained.

11. A computer-readable storage medium storing instructions for obtaining a file, the instructions comprising:
obtaining a file size of a target file;
determining whether the file size of the target file is larger than a maximum file size transfer limit; and
if yes, obtaining a file segment of the target file each time, until the entire target file being obtained, wherein the file segment is segmented from the target file according to the maximum file size transfer limit.

12. The computer-readable storage medium as claimed in claim 11, wherein the step of obtaining a file size of a target file comprises:
sending a request information to a server for obtaining the file size of the target file; and
receiving a response information sending back from the server according to the request information, and obtaining the file size of the target file from a message header information of the response information.

13. The computer-readable storage medium as claimed in claim 12, wherein the step of obtaining a file segment of the target file each time, until the entire target file being obtained comprises:
requesting for obtaining a file segment;
once the file segment being obtained, determining whether a remaining size of the target file is larger than the maximum file size transfer limit, wherein the remaining size is a file size of the target file removing the part has been obtained;
if the remaining size is larger than the maximum file size transfer limit, obtaining another file segment; and
if the remaining size is smaller than or equal to the maximum file size transfer limit, obtaining the target file removing the part has been obtained.

14. The computer-readable storage medium as claimed in claim 11, wherein the step of obtaining a file size of a target file comprises:
sending a request information to a server for obtaining a first file segment of the target file, wherein the request information further comprises a request for obtaining the file size of the target file and a size of the first file segment; and
obtaining the first file segment and receiving a response information sending back from the server according to the request information, wherein the response information comprises the file size of the target file and the size of the first file segment.

15. The computer-readable storage medium as claimed in claim 14, wherein the step of obtaining a file segment of the target file each time, until the entire target file being obtained, comprises:
requesting for an un-obtained file segment;
once one un-obtained file segment being obtained, determining whether a remaining size of the target file is larger than the maximum file size transfer limit, wherein the remaining size is a file size of the target file removing the part has been obtained;
if the remaining size is larger than the maximum file size transfer limit, obtaining another file segment; and
if the remaining size is smaller than or equal to the maximum file size transfer limit, obtaining the target file removing the part has been obtained.
